(19) United States
(12) Patent Application Publication
(10) Pub. No.: US 2006/0123943 A1
(43) Pub. Date: Jun. 15, 2006

(54) Gear knob

(75) Inventors: Klaus Huber, Landshut (DE); Lukas Armada, Vilsbiburg (DE)

Correspondence Address: WOLF GREENFIELD & SACKS, PC;FEDERAL RESERVE PLAZA, 600 ATLANTIC AVENUE, BOSTON, MA, 02210-2206, US

(73) Assignee: Lisa Draxlmaier GMBH, Vilsbiburg (DE)

(21) Appl. No.: 11/269,130

(22) Filed: Nov. 7, 2005

(30) Foreign Application Priority Data
Nov. 5, 2004 (DE) 10 2004 053 576.0

(51) Int. Cl. G05G 1/10

(52) U.S. Cl. 74/543

(57) ABSTRACT

A gear knob capable of assembly onto or removal from a gear stick of a vehicle as a sub assembly and/or without the use of tools. The gear knob has a latch that engage with an axial interlocking section of the gear stick. A manipulation device formed integrally with a retaining sleeve of the gear knob can move the latch away from the interlocking section of the gear stick.

### BACKGROUND OF INVENTION

1. Field of Invention

The present invention relates to a gear knob for assembly onto a gear stick of a vehicle, such as a motor vehicle.

2. Discussion of Related Art

Gear knobs are known in the prior art. For example, DE 197 50 031 A1 discloses a manual gear lever for a motor vehicle. Here, the gear knob is assembled onto a gear stick by first pushing an operating sleeve onto the gear stick. A spring is then slipped over the gear stick and is supported with one end on the operating sleeve. Then a retaining sleeve, which has a shoulder that supports the spring, is slipped onto the gear stick. The basic body of the gear knob has a latching means designed to pivot elastically outwards from an engaged position. The gear stick has an annular groove at an axial interlocking section. To install the gear knob on the gear stick, the gear knob is pushed onto the gear stick. The latching means slides downwards on the gear stick, engages with the top shoulder of the retaining sleeve and presses the retaining sleeve downwards against the spring that is supported on the operating sleeve. When the latching means engages with the annular groove, the retaining sleeve can slip over the latching means and fix it in the engaged position. Movement of the retaining sleeve over the latching means is due to the spring force. To disassemble the gear knob, a spacer in front of the operating sleeve on the gear stick is removed and the operating sleeve is pushed downwards. This provides access to the retaining sleeve for a tool, like a screwdriver, such that the sleeve can be pushed. The gear knob can then be pulled up and off. To repeat the assembly, the procedure is repeated once a new spacer has been replaced on the gear stick.

The above prior art comprises a gear knob, retaining sleeve, spring, operating sleeve, spacer and gear stick, each of which is a discrete component that is separate from the others (i.e. individual parts). These components, with the exception of the gear stick, must be supplied separately and assembled one after the other. This can require additional space during assembly for the individual components. Additionally, the margin for error during assembly is increased due to the large number of components. Moreover, a tool is necessary at least for disassembling the gear lever system described above.

### SUMMARY

According to one aspect of the invention, a gear knob for assembly on a gear stick of a vehicle is disclosed. The gear stick has an axial interlocking section. The gear knob comprises a basic body and a receiving section that extends axially in the basic body and that has an aperture for receiving the gear stick. A latching means is joined to the basic body and can be brought into engagement with the axial interlocking section of the gear stick. The latching means can be moved from an engaged position in a direction away from the gear stick. The gear knob also comprises an axially movable retaining sleeve for fixing the engagement of the latching means with the axial interlocking section. An elastic element is supported with one end on the retaining sleeve. The elastic element pre-tensions the sleeve to a retaining position in which position the retaining sleeve is disposed at least partially over the latching means and fixes the latching means in the engaged position. A manipulation device is formed integrally with the retaining sleeve and is adapted to axially displace the retaining sleeve. The gear knob also comprises a limit nib on the latching means with which the retaining sleeve is in contact in the retaining position, wherein another end of the elastic element opposite the one end is supported on a basic body side.

According to another aspect of the invention, a gear knob is disclosed for assembly onto a gear stick that has an interlocking section. The gear knob comprises a body and a latch joined to the body. The latch is adapted to engage the interlocking section of the gear stick when the latch is in an engagement position. A manually operable movable device is operatively coupled to the latch and is adapted to cause movement of the latch into and out of the engagement position. The gear knob further includes a limit nib operatively coupled to the movable device, the limit nib is adapted to limit movement of the movable device.

According to yet another aspect of the invention, a method is disclosed for assembling a gear knob subassembly onto a gear stick that has an interlocking section. The method comprises providing a gear knob subassembly that includes a body, a latch that can be brought into engagement with the interlocking section in an engaged position, and a manipulation device adapted to move the latch into engagement with the interlocking section. The method also comprises moving the manipulation device axially toward the body to move the latch away from the engaged position, sliding the gear knob subassembly onto the gear stick, and releasing the manipulation device to allow the latch to move toward the engagement position.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. Various embodiments of the invention will now be described, by way of example, with reference to the accompanying drawings, in which:

FIG. 1 is a cross-sectional view of one embodiment of a gear knob.

FIG. 2 is a cross-sectional view of the gear knob shown in FIG. 1 in a rotated position and mounted on a gear stick.

FIG. 3 is a cross-sectional view of the gear knob shown in FIG. 2 in an unlatched position.

### DETAILED DESCRIPTION

Aspects of the present invention provide for improved assembly and disassembly of the gear knob onto and from a gear stick. Aspects of the present invention are directed to a gear knob that is configured as an integral unit and that can easily be manually attached and axially interlocked on the gear stick and disassembled without using additional components and without additional tools.

Aspects of the present invention provide a gear knob for assembly onto a gear stick of a vehicle, such as a motor vehicle. The stick may have an axial interlocking section. The gear knob may include a basic body, representing the main part of the gear knob, that when assembled to the gear lever, provides the manipulable part of the gear lever. The basic body may be designed to function both haptically and optically as a manipulation device. The basic body may have a receiving section to enable the basic body to be slipped onto the gear stick. The receiving section may extend in an axial direction, i.e. a direction in which the gear stick is inserted into the basic body. The receiving section may also be considered a cut-out. The receiving section may be formed with an aperture that has a complementary shape to the top end of the gear stick. Although one embodiment includes a receiving section, the present invention is not limited in this respect.

The gear knob, according embodiments of the invention, may have a latch joined to the basic body that may be brought into engagement with the axial interlocking section of the gear stick. The latch can be pivoted or moved in a direction perpendicular to the axial direction out of an engaged position. That is, the latch may be pivotable in such a manner that it can be swiveled or moved away from the gear stick out of a home position. In one embodiment, an elastic latch is joined to the basic body. The latch may be pivotable against a spring force and may spring back to its home position without load. Alternatively, the latch may be a separate latching element supported around an axis that can be pivoted both away from the gear stick, as the present invention is not limited in this respect. Such an element may also be spring-loaded. The latch may have latching nibs intended to engage behind an axial interlocking projection or in an axial interlocking groove.

Embodiments of the gear knob may have an axially movable retaining sleeve to fix the latch in the latched position with the axial interlocking section. An elastic element may be supported with one end on the retaining sleeve and may pre-tension the retaining sleeve in the direction of a retaining position. Although one embodiment includes an elastic element, the present invention is not limited in this respect. In the retaining position, the retaining sleeve may be at least partially disposed over the latch to fix the latch in the engaged position. That is, the retaining sleeve may prevent the latch from swiveling or moving in the direction perpendicular to the axial direction in order to hold the latch in the engaged position/home position. Although one embodiment includes a retaining sleeve, it should be appreciated that the present invention is not limited in this respect.

Embodiments of the gear knob may have a manipulation device formed integrally with the retaining sleeve that enables manual (by hand) axial movement of the retaining sleeve. However, it should be appreciated that the manipulation device need not be integrally formed with the retaining sleeve, as the present invention is not limited in this respect. A limit nib can be provided on the latch that contacts the retaining sleeve in the retained position. The elastic element can be supported with its other end on the basic body side, such that in the retained position the retaining sleeve is clamped between the limit nib on the latch and the elastic element. This can enable secure fixing of the latch in the engaged position. The phrase, “on the basic body side”, is to be understood to mean that the elastic element is supported on the side adjacent the basic body, and should not be interpreted to mean direct support on the basic body (that is, elements may be inserted between the elastic element and the basic body such with the elastic element still be considered to be supported on the basic body side).

Components of the gear knob, according to some embodiments, may be provided as a standard subassembly. The subassembly may be attached to the gear stick by pushing the manipulation device axially towards the basic body to move a retaining sleeve out of the retaining position. This may make it possible to interlock the manipulation device axially on the gear stick with the latch to move the retaining sleeve into the retaining position. This axial displacement can be caused simply by releasing the manipulation device. Disassembly of the gear knob may take place by axial displacement of the manipulation device in the direction toward the basic body to move the retaining sleeve out of the retaining position. This may release the latch such that the gear knob can be pulled off the gear stick in a disassembly direction.

In some embodiments, the latch can be molded onto a sleeve-shaped clamping element, (i.e. formed integrally with the clamping element). The latch can include a plurality of latching hooks or latching nibs molded onto the clamping element and interrupted by cut-outs. Such a design may make it possible to form the latch and the clamping element relatively easily as an injection molded part. The circumjacent arrangement of the latching hooks can help ensure a reliable axial interlock without canting. In this case, the term clamping element is not restricted to an element that has a clamping action, as aspects of the present invention are not limited in this regard.

In some embodiments, the clamping element has a circular cross-section. However, other cross-sections, such as rectangular or square, are also conceivable as the invention is not limited in this respect.

Embodiments of the clamping element may be designed with a double-wall. In such embodiments, the inner wall may include the latch or the latching hooks and the outer wall may be provided with cut-outs. The manipulation device may, at least partially, surround the outer wall and be formed integrally with the retaining sleeve. This may be accomplished by spokes that engage through the cut-outs in the outer wall. As a result, the manipulation device and the retaining sleeve may be guided by the clamping element to effectively prevent or reduce the possibility of canting of the retaining sleeve or the manipulation device.

According to one embodiment, the elastic element is disposed between the inner wall and the outer wall of the clamping element. The elastic element may be supported on its base body side on a section of the clamping element that joins the outer wall and the inner wall. In other words, the inner wall and the outer wall of the clamping element are joined by a section that faces the basic body whereas the clamping element is essentially open on the side facing away from the basic body. A limit nib on the latch is formed in such a manner that the aperture between the latch and the outer wall is smaller than the wall thickness of the retaining sleeve. This can prevent the retaining sleeve with the elastic element from slipping out of the space between the inner wall, outer wall and the joining section. The elastic element may be supported with its other end on the retaining sleeve that is movable between the outer wall and the inner wall. This can allow manipulation of the device and the retaining sleeve as a movable component that is incorporated with the gear knob such that the gear knob forms an integral unit.

As discussed herein, the inner wall, the outer wall, the limit nib and the section joining the walls define a space in which the retaining sleeve and the elastic element may be accommodated and guided. The internal diameter of the retaining sleeve may corresponds substantially to the external diameter of the inner wall formed by the latching hooks when said latching hooks are in the engaged position. This can ensure reliable fixing of the latch or the latching hooks in the engaged position.

The gear knob assembly may include a flexible cover (e.g., a leather bellows) that covers the joint between the gear stick and the bearing block when the gear knob and the gear stick are in the assembled condition. In order to attach the flexible cover element to the gear knob, the clamping element may be locked onto the receiving section by means of a latching nib provided in the vicinity of the opening and the cover element is clamped between the basic body and the clamping element. The cover element is not restricted to a leather bellows and other flexible cover elements may also be used. In one embodiment, the clamping element may provide multiple function, such as a carrying function for the latching means, a guiding function for the retaining sleeve and the manipulation device, and/or a clamping action for attaching the flexible cover element to the gear knob.

In an illustrative embodiment, the latching nibs of the receiving section engage in the cut-outs of the clamping element that are already provided and that are situated between the latching hooks and separate them from one another. As a result, elements that are already provided are used to latch the clamping element with the receiving section for clamping of the flexible cover element and the configuration of clamping element remains technically simple.

One or more marks may be provided stationary to the basic body to indicate, during assembly, whether the retaining sleeve is in the retaining position or in an unlatched position. The mark may terminate with the top edge or the bottom edge of the manipulation device in either the retaining position or the unlatched position. If the mark and the top or bottom edge are appropriately aligned, an assembler will be advised that the manipulation device or the retaining sleeve, respectively, is located in the correct position. According to one embodiment, two marks are provided on the basic body, which indicate the retaining position or the unlatched position, respectively. In other embodiments, this can be achieved with a mark that is aligned with the top edge of the manipulation device and in the other position with the bottom edge.

In some embodiments, the elastic element is a spring.

The gear stick may have a substantially circular cross-sectional shapes with at least one straight side at its top end. The receiving section may have a cross-section that corresponds to that of the gear knob. That is, the receiving section may be substantially circular in cross-sectional shape with at least one straight side. Such an embodiment may prevent skewing, particularly in the case of a substantially circular gear sticks.

Embodiments may have a limit stop provided on the end of the receiving section that faces away from the aperture. The limit stop may align the gear knob on the gear stick to lock it in place. Here, the distance from the limit stop to the latch is designed to correspond to the distance from a top limit surface of the gear stick to the axial interlocking section.

As discussed herein, the retaining sleeve with the integrally formed manipulation device, the elastic element, the latch and the basic element with the receiving section may be a pre-assembled unit that is delivered complete and that only has to be placed on the gear stick and locked into position.

The present invention also proposes a gear lever in a vehicle having a gear stick with an axial interlocking section and a gear knob described herein, in which the latch and the axial interlocking section are engaged with one another.

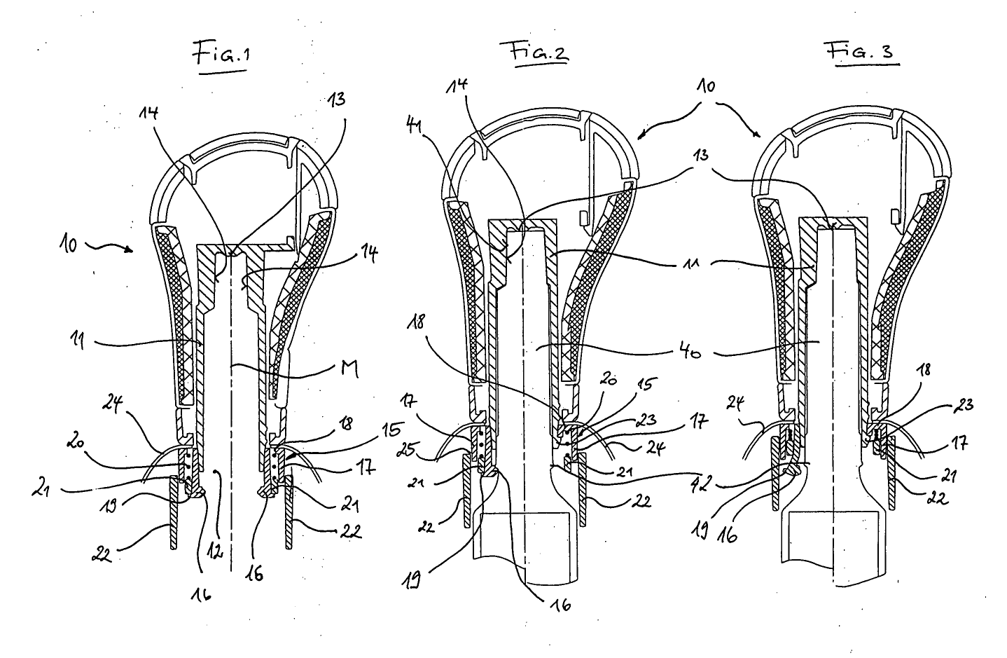

Turning now to the figures, FIGS. 1 to 3 show different cross sectional views of an illustrative embodiment of a gear knob. The gear knob comprises a basic body 10. The basic body 10 forms a main part of the gear knob and, in the assembled condition, serves for operating and handling of the gear stick 40. The basic body 10 may have an outer surface that is constructed with haptics and optical appearances in mind, although aspects of the invention are not limited in this regard. The present invention is not limited to any one particular construction of the basic body 10, such as to any coatings or materials that are used in the basic body.

The basic body 10 includes a receiving section 11. In the illustrated embodiment, the receiving section is a cut-out that extends along the axial direction of the basic body 10. As shown, the cut-out of the receiving section 11 extends along a centerline M, also the direction in which the gear knob is slipped onto the gear stick. Receiving section 11 has an aperture 12 at one end that receives gear stick 40 when the gear stick 40 is inserted into the receiving section 11. A limit stop 13 is provided at the end of the receiving section 11 opposite to the aperture 12. In the illustrated embodiment, the receiving section 11 is an integral component of the gear knob 10, although the invention is not limited in this regard.

The gear knob embodiment shown in the figures is adapted to receive a gear stick that has a substantially circular cross-section. However, the illustrated gear stick 40 may include flattened portions, such as the two straight sides 41 adjacent to an upper end of the gear stick 40 shown in the figures. The illustrated receiving section 11 has a complementary cross-section adjacent the end opposite to the aperture 12 with a cross-section that is flattened on two sides, as shown in FIG. 1 by reference number 14. Engagement of the complementary cross-sections of the receiving section 11 and the gear stick 40 may aid in preventing gear knob 10 from twisting when mounted on gear stick 40.

Embodiments of the gear knob may include a latch joined to the basic body 10 that can be engaged with an axial interlocking section 42 of the gear stick. The axial interlocking section of the gear stick 40 is illustrated in the figures as a circumferential projection. However, aspects of the invention are not limited in this regard, as the interlocking section can be also be an annular groove, or other features.

In one embodiment, the gear knob may include a latch molded onto a sleeve-shaped clamping element 15, as shown. The clamping element can include a plurality of latching hooks 16 that are interrupted by cut-outs molded into the clamping element 15. The latching hooks 16 may be formed integrally with the sleeve-shaped clamping element 15 and may comprise an elastic material. Forming the latching hooks in this manner may allow the latching hooks 16 to spring outwards, in a direction away from the centreline M, or away from the gear stick 40 (i.e., in a direction perpendicular to the axial direction). Clamping element 15 can have a substantially circular cross-section. The illustrated clamping element includes a double-walled design with an inner wall formed by latching hooks 16 and an outer wall 17 with cut-outs (not shown). The latching hooks 16 of the inner wall are connected to the outer wall 17 by way of a joining section 18. A space is formed between the inner wall and the outer wall. The latching hooks 16 include limit nibs 19 opposed to the joining section 18, such that a space is formed between the inner wall 16, the outer wall 17, the joining section 18 and the limit nibs 19. The space can include an elastic element, such as a spring 20. This elastic element 20, as illustrated, is supported at one end by the joining section 18 of the clamping element 15. The opposite end of the elastic element 20 is supported on a retaining sleeve 21 that at least partially surrounds the latching hooks or inner wall. In the illustrated embodiment, the internal diameter of the retaining sleeve 21 is essentially the same as the outer diameter of the latching hooks 16.

In the illustrated embodiment, a manipulation device 22 is formed integrally with the retaining sleeve 21, at least in the vicinity of limit nibs 19. The manipulation device 22 at least partially surrounds the outer wall 17 of the clamping element 15. The internal diameter of the manipulation device corresponds approximately to the external diameter of the outer wall 17 so that the retaining sleeve 21 and the manipulation device 22 may be guided by the inner wall 16 and outer wall 17. The manipulation device 22 may be joined to the retaining sleeve 21 by means of spokes (not illustrated), that engage through cut-outs (not illustrated) in the outer wall 17 of the clamping element 15.

Multiple latching nibs 23 may be provided on the apron of the receiving section 11 near the aperture 12. The latching nibs can engage the cut-outs (not illustrated) between the latching hooks 16 of the clamping element 15 to connect to the basic body 10 and the receiving section 11. A flexible cover element, such as a leather bellows, may be clamped between the clamping element 15 and the basic body 10. The cover may be slightly elastic, at least in the axial direction, and may be slightly greater in thickness than the distance between the basic body 10 and the clamping element 15 in the locked condition. By locking the clamping sleeve 15 with the latching nibs 23, the elastic cover element 24 is elastically compressed until the clamping element 15 locks into place behind the latching nibs 23. This results in the flexible cover element 24 being clamped securely between the clamping element 15 and the basic body 10. At the same time, the clamping element 15 is locked into position with the basic body so as to be tolerance-free.

The components of the gear knob, as described above and as shown in FIG. 1, may be configured as a pre-assembled unit and form a gear knob that is to be attached to a gear stick 40.

One exemplary process for installing the gear knob on gear stick 40 and a corresponding process for its removal are described below.

To install the gear knob 10, the manipulation device 22 is pushed against the spring force of the elastic element 20 to move the retaining sleeve 21 out of the engaged position, in which position the latching hooks 16 are disposed inward, and into an unlatched position, as shown in FIG. 3. That is, the manipulation device 22 is pushed linearly or axially towards the basic body 10 to shift the retaining sleeve 21, which is formed integrally with manipulation device 22, into the unlatched position. As a result of this movement, the latching hooks 16 are released and can swing out away from the gear stick 40. The gear knob can be pushed onto the gear stick 40, by inserting the gear stick into the aperture 12 of the gear knob receiving section 11. The gear knob can be pushed onto the gear stick until the upper end of gear stick 40 engages with the limit stop 13 of the receiving section 11. In this regard, the limit stop can prevent further movement of the gear knob with respect to the gear stick. The latching hooks 16 may be held apart by the gear stick itself as the gear knob is installed onto the gear stick. This can be accomplished, in some embodiments, because the cross sectional area of the gear stick above the engaged position has a larger diameter than the area below the engaged position. As a result, the manipulation device does not have to be held as the gear knob is installed up to the limit stop. The distance from the limit stop 13 to the latching hooks 16 may correspond to the distance between the top end or the top end face of the gear stick 40 and the axial interlocking section 42. When the end face of gear stick 40 reaches the limit stop 13, the latching hooks 16 snap into place over the axial interlocking section 42, that is in the shape of a circumferential band. In other words, the latching hooks 16 engage behind the band 42. In other embodiments, the latching hooks 16 can also snap into an engaging portion that comprises a circumferential annular groove.

The elastic element 20 automatically presses the retaining sleeve 21 together with the manipulation device 22 into the engaged position, such that the latching hooks are engaged. In this position, the retaining sleeve 21 is disposed at least partially over the latching hooks 16, which helps fix the latching hooks in the engaged position, as shown in FIG. 2. The retaining sleeve helps secure the latching hooks 16 in the engaged position to prevent radial slippage or twisting away from gear stick 40. There is no need to actively move the manipulation device downwards.

In one embodiment, a visual check may be provided to establish when the engaged position of manipulation device 22 has been reached. A mark may be provided on the clamping element 15 in the area noted by reference number 25. The mark may indicate alignment with the top edge of manipulation device 22 and thus indicate that manipulation device 22 is located in the engaged position.

As discussed herein, embodiments of the gear knob may be provided as a pre-assembled unit, such that the gear knob can be installed to a gear stick without requiring any additional elements and without requiring any additional structural elements or tools. In illustrative embodiments, it may only be necessary to compress the spring by movement of the manipulation device 22 and to push the gear knob onto gear stick 40 up to the limit stop. Afterwards, the gear knob is fixed or locked onto gear stick 40 automatically by the movement of retaining sleeve 21 over latching hooks 16 by virtue of the spring.

In one embodiment, to remove the illustrated embodiment of the gear knob, the manipulation device 22 is moved toward the basic body 10 (that is, in a direction opposite to the direction in which the gear knob is moved for installation onto the gear stick). This movement is against the spring force of elastic element 20. As a result, movement of the retaining sleeve 21, which is pushed together with the manipulation device 22, caused the release of latching hooks 16. The latching hooks can then swing out away from gear stick 40. By pulling axially on the gear knob, the latching hooks 16 can be disengaged from the axial interlocking section 42 of gear stick 40 and the gear knob can be pulled off of the gear stick 40. In this regard, there is no need for tools to disassemble the gear knob of the present invention—manual movement of manipulation device 22 is sufficient.

The gear knob of the present invention offers advantages compared to the known prior art. By way of non-limiting example, it can form a pre-assembled unit that can be installed onto and also removed from a gear stick of a motor vehicle or another vehicle without additional elements or tools.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A gear knob for assembly on a gear stick of a vehicle, the gear stick having an axial interlocking section, the gear knob comprising:
a basic body;
a receiving section extending axially in the basic body and having an aperture for receiving the gear stick;
a latching means joined to the basic body and that can be brought into engagement with the axial interlocking section of the gear stick, wherein the latching means can be moved from an engaged position in a direction away from the gear stick;
an axially movable retaining sleeve for fixing the engagement of the latching means with the axial interlocking section;
an elastic element supported with one end on the retaining sleeve, the elastic element pre-tensioning the sleeve to a retaining position in which position the retaining sleeve is disposed at least partially over the latching means and fixes the latching means in the engaged position;
a manipulation device formed integrally with the retaining sleeve and adapted to axially displace the retaining sleeve; and
a limit nib on the latching means with which the retaining sleeve is in contact in the retaining position, wherein another end of the elastic element opposite the one end is supported on a basic body side.

2. The gear knob according to claim 1, wherein the latching means is molded onto a sleeve-shaped clamping element and includes a plurality of latching hooks molded onto the clamping element and interrupted by cut-outs.

3. The gear knob according to claim 2, wherein the sleeve-shaped clamping element has a substantially circular cross-section.

4. The gear knob according to claim 2, wherein the clamping element is designed with a double-wall, including an inner wall formed of latching means and an outer wall with cut-outs in which the manipulation device at least partially surrounds the outer wall and is formed integrally with the retaining sleeve by way of spokes that engage through the cut-outs in the outer wall.

5. The gear knob according to claim 4, wherein the elastic element is disposed between the inner wall and the outer wall of clamping element and is supported on the basic body side by a section of the clamping element that joins the outer wall and the inner wall, and wherein the other end of the elastic element is supported on the movable retaining sleeve between the outer wall and the inner wall.

6. The gear knob according to claim 5, wherein the inner wall, the outer wall, the limit nib and the section of the clamping element that joins the outer wall and the inner wall define an intermediate space in which the retaining sleeve and the elastic element are located.

7. The gear knob according to claim 2, wherein the clamping element includes a latching nib provided in the vicinity of the aperture that is lockable onto the receiving section, and further comprising a flexible cover element that is clamped between the basic body and the clamping element.

8. The gear knob according to claim 7 in which the latching nib of the receiving section engages in cut-outs of the clamping element.

9. The gear knob according to claim 1, wherein at least one mark is provided stationary to the basic body and aligned with a top edge and/or a bottom edge of the manipulation device when the retaining sleeve is in either the retaining position and/or an unlatched position.

10. The gear knob according to claim 1, wherein the elastic element is a spring.

11. The gear knob according to claim 1, wherein the receiving section has a substantially circular cross-section that changes in the vicinity of a side facing away from the aperture to a cross-section with at least one straight side.

12. The gear knob according to claim 1, wherein a limit stop is provided on the end of the receiving section which faces away from the aperture and a distance from the limit stop to the latching means corresponds to a distance from a top limit surface of the gear stick to the axial interlocking section.

13. The gear knob according to claim 1, wherein the retaining sleeve with the integrally formed manipulation device, the elastic element, the latching means and the basic element with the receiving section form a pre-assembled unit.

14. The gear knob according to claim 1, in combination with a gear lever in a vehicle with a gear stick having an axial interlocking section, wherein the latching means and the axial interlocking section are engaged with each other.

15. A gear knob for assembly onto a gear stick having an interlocking section, the gear knob comprising:
a body;
a latch joined to the body, the latch adapted to engage the interlocking section of the gear stick when the latch is in an engagement position;
a manually operable movable device operatively coupled to the latch and adapted to cause movement of the latch into and out of the engagement position; and
a limit nib operatively coupled to the movable device, the limit nib adapted to limit movement of the movable device.

16. The gear knob according to claim 15, wherein at least the body, latch, movable device and limit nib are assembled in a manner to provide a pre-assembled unit that is adapted for attachment to the gear stick.

17. A method of assembling a gear knob subassembly onto a gear stick that has an interlocking section, the method comprising:
providing a gear knob subassembly comprising a body, a latch that can be brought into engagement with the interlocking section in an engaged position, and a manipulation device adapted to move the latch into engagement with the interlocking section;
moving the manipulation device axially toward the body to move the latch away from the engaged position;
sliding the gear knob subassembly onto the gear stick; and
releasing the manipulation device to allow the latch to move toward the engagement position.
